(19) United States
(12) Patent Application Publication
(10) Pub. No.: US 2013/0101468 A1
(43) Pub. Date: Apr. 25, 2013

(54) METHOD AND APPARATUS FOR CONTROLLING THE PROPAGATION OF CYANOBACTERIA IN A BODY OF WATER

(71) Applicants: Marcel Boutin, Drummondville (CA); Linda Yergeau, Notre-Dame-de-l'Ile-Perrot (CA)

(72) Inventors: Marcel Boutin, Drummondville (CA); Linda Yergeau, Notre-Dame-de-l'Ile-Perrot (CA)

(21) Appl. No.: 13/505,512

(22) PCT Filed: Nov. 2, 2010
(86) PCT No.: PCT/CA2010/001709

§ 371 Date: Dec. 17, 2012

Related U.S. Application Data
(60) Provisional application No. 61/257,560, filed on Nov. 3, 2009.

(51) Int. Cl. C02F 1/36

(52) U.S. Cl. CPC C02F 1/36
USPC 422/128

(57) ABSTRACT

An apparatus for controlling the cyanobacteria comprising a floatation platform having anchor means to position said platform on a body of water, an ultrasonic generator secured to said platform and adapted to generate ultrasonic waves at below and top of said body of water, and supply means to cause said ultrasonic generator suspended at a predetermined depth to emit ultrasonic waves, of a predetermined frequency, at a predetermined power level, to sever the chemical link existing between an accessory pigment and the chlorophyll a, both present in the photosynthesis system of the cyanobacteria, as well as a method for preventing, controlling or inhibiting the cyanobacteria population in a body of water

### TECHNICAL FIELD

The present invention relates to a method and apparatus for controlling the cyanobacteria and more particularly those of the blue-green algae type and/or of the red tide type.

The present invention also relates to the use of the apparatus of the invention, alone or in combination with complementary means, for preventing or inhibiting the growth of cyanobacteria in a body of water. The invention additionally relates to the use of the apparatus and/or of the method of the invention for preventing and for inhibiting a cyanobacteria population.

### BACKGROUND

In recent years, various attempts to kill cyanobacteria by ultrasound have been initiated throughout the world. In most cases, the target was the pseudo-Vacuole that forms within the cyanobacteria, which makes it float at the surface thus allowing the production of chlorophyll under the influence of the Sun. It is known that an ultrasonic wave at 1.7 MHz can be efficient to explode the pseudo-Vacuole.

However, the higher is the frequency of an ultrasonic wave, the faster is its damping in the propagation medium. A 1.7 MHz frequency is too high to allow the ultrasonic wave to propagate over long distances in water, which does not make an effective solution when large diffusion areas are required, as in lakes for example.

It is known than an ultrasonic wave at 1.7 MHz can be efficient to explode the pseudo-Vacuole (Jiao Wen Tang, Qing Yu Wu, Hong Wei Hao, Yifang Chen, Minsheng Wu, “Effect of 1.7 MHz ultrasound on a gas-Vacuole cyanobacterium and a gas-Vacuole negative cyanobacterium”, Colloids and Surfaces B: Biointerfaces 36 (2004) 115-121).

While trying to tackle the pseudo-Vacuole Hao et al., in (Hongwei Hao, Minsheng Wu, Yifang Chen, Jiaowen Tang, and Qingyu Wu, in “Cyanobacterial Bloom Control by Ultrasonic Irradiation at 20 KHz and 1.7 MHz”, JOURNAL OF ENVIRONMENTAL SCIENCE AND HEALTH, Part A—Toxic/Hazardous Substances & Environmental Engineering, Vol. A39, No. 6, pp. 1435-1446, 2004), noted the impact of ultrasounds on the phycocyanin and confirmed the termination of the chemical link between accessory pigments (such as the phycocyanin) and chlorophyll a, followed by the destruction of the chemical structure of the phycocyanin.

However none of those documents described any apparatus based on ultrasonic waves allowing an efficient control of a cyanobacteria population in a contaminated site.

There was therefore a need for an apparatus based on ultrasonic technology that may be used on the site to efficiently control cyanobacteria population in a contaminated site.

### SUMMARY

An apparatus for controlling the cyanobacteria comprising a floatation platform having anchor means to position said platform on a body of water, an ultrasonic generator secured to said platform and adapted to generate ultrasonic waves at below and top of said body of water; and supply means to cause said ultrasonic generator suspended at a predetermined depth to emit ultrasonic waves, of a predetermined frequency, at a predetermined power level, to sever the chemical link existing between an accessory pigment and the chlorophyll a, both present in the photosynthesis system of the cyanobacteria; as well as a method for preventing, controlling or inhibiting the cyanobacteria population in a body of water.

Further details on these aspects as well as other aspects of the proposed concept will be apparent from the following detailed description and the appended figures.

### BRIEF DESCRIPTION OF THE FIGURES

FIG. 1 is a graph illustrating the variations of the fluorescence of the cyanobacteria as a function of frequency with an excitation voltage of 360 Vpp with a sample prepared according the PROTOCOL FOR PREPARING SAMPLES;

FIG. 2 is a graph similar to FIG. 1 illustrating the variations of the fluorescence of the cyanobacteria as a function of frequency with an excitation voltage of 200 Vpp with a sample prepared according to the PROTOCOL FOR PREPARING SAMPLES;

FIG. 3 is a schematic isometric view of an apparatus, according to a first preferred embodiment of the invention, for destroying blue-green algae, with a solar panel on is top;

FIG. 4 is a schematic cross-section view of the apparatus represented in FIG. 3, showing the floatation platform 10, the solar panel 11, the electronic driving circuit (14 and 15) implemented inside the floating platform, the transducer 16 and the diffuser part 12;

FIG. 5 is a schematic illustration of the low profile ultrasonic field generated by the transducer present in the apparatus according to FIGS. 3 and 4;

FIG. 6 is a block diagram of the electronic driving circuit of the apparatus according to FIGS. 3, 4 and 5,

FIG. 7 is a simplified isometric view of an apparatus, according to a second embodiment of the invention, for destroying blue-green algae;

FIGS. 8 to 11 are various views of the piezoelectric transducer, adapted to generate a low profile lobe (narrow beam), of the apparatus as present in the apparatus according to FIG. 7;

FIG. 12 is an isometric view of the solar system present in the apparatus according to FIG. 7;

FIG. 13 is a graph illustrating the variations of the fluorescence of the cyanobacteria as a function of frequency at a power level of 360 Vpp;

FIG. 14 is a graph similar to FIG. 3 illustrating the variations of the fluorescence of the cyanobacteria as a function of frequency at a power level of 200 Vpp; and

FIG. 15 is a schematic illustration of the frequency lobe (narrow beam) generated by the transducers.

### DETAILED DESCRIPTION

### Preliminary Definitions

Body of water: any body of water essentially constituted of water, but not essentially of water, for example may contain liquid or solid contaminants that may generate the cyanobacteria contamination, may also contain organic life alone or in combination with other components of the body of water), they may be of a natural or human or industrial origin. Body of water means already contaminated body of water or a body of water that may potentially contaminated.

A narrow ultrasonic beam: an ultrasonic beam characterized in that its diffusion is limited to a determined area and/or is under control.

Radius: the measure of the diffusion area without consideration to the efficiency of the ultrasonic beam in respect of the breaking of the chemical bond between the phycocyanin and the chlorophyll a.

Operative radius: radius of the diffusion area wherein the ultrasonic has is maximum efficiency in respect of the breaking of the chemical bond between the phycocyanin and the chlorophyll a.

Pigment: in the framework of the present application is a naturally colored substance produced by vegetable organism, for example the phycocyanin (blue-green) and the fucoxanthin (red) that are related to cyanobacteria.

Accessory pigment: also use by some authors to refer to a pigment as defined in the previous paragraph.

According to a first broad aspect of the present invention, there is provided an apparatus for controlling cyanobacteria (that are for example of the blue-green and/or red tide algae), said apparatus comprising a floatation platform having anchor means to position said platform at a predetermined substantially stable position on a body of water, said platform having an ultrasonic generator secured thereto and adapted to generate a predetermined frequency at and below a top surface of said body of water, supply means to cause said ultrasonic generator to emit said predetermined frequency at a predetermined power level to severe the chemical link between an accessory pigment (such as phycocyanin or such as fucoxanthin) and chlorophyll a, for example to break the chemical bond existing between the phycocyanin and the chlorophyll a of the photosynthesis system of the cyanobacteria, preferably of said blue-green and/or red tide algae.

Preferably, the apparatus is used for controlling the cyanobacteria, wherein the cyanobacteria are those present in blue-green algae and the chemical link is between phycocyanin and chlorophyll a.

Advantageously, the apparatus is used for controlling the cyanobacteria, wherein the cyanobacteria are those present in red tide and the chemical link is present between fucoxanthin and chlorophyll a.

According to a preferred embodiment, the apparatus for controlling the cyanobacteria, preferably of the blue-green algae type, comprises:
a floatation platform having anchor means to position said platform on a body of water;
an ultrasonic generator secured to said platform and adapted to generate ultrasonic waves at below and top of said body of water; and
supply means to cause said ultrasonic generator suspended at a predetermined depth to emit said ultrasonic waves, of a predetermined frequency, at a predetermined power level, to break the chemical bond existing between the phycocyanin and the chlorophyll a, both present in the photosynthesis system of the cyanobacteria.

Advantageously, the ultrasonic frequency generator is a piezoelectric transducer having a diffuser (wave guide component) configured to produce an oriented narrow ultrasonic beam. This narrow ultrasonic beam has preferably a circular diffusion area and according to a preferred embodiment, the circular diffusion area extends over a radius of 100 meters.

According to a preferred embodiment, the apparatus of the invention is design to generate a circular diffusion area having an average depth, measured from the surface of said body of water and in direction of the bottom that ranges from 0 to 3 meters and preferably ranges from 0 to about 2 meters.

Advantageously, the circular diffusion area has an ultrasonic operative radius ranging from 75 to 100 meters, and this radius is preferably of about 100 meters.

Preferably, the diffuser component is an inverted cone positioned on a support base secured at a predetermined distance below said transducer.

It is preferred that the predetermined distance below said transducer ranges from 10 to 20 cm, and preferably ranges from 10 to 15 cm, and more preferably is about 13 cm.

In the apparatus of the invention, the cone of the diffuser component is characterized in that the diameter of the cone basis is preferably greater or equal to the diameter of the transducer.

The angle at the basis of the cone advantageously ranges from 30 to 80 degrees, and preferably from 40 to 50 degrees, and more preferably is about 45 degrees.

According to a preferred embodiment, the supply means is an energy supply, preferably with a voltage ranging from 11.5 to 18 Volts, more preferably the energy supply has a voltage of 12 Volt.

According to another preferred embodiment, the supply means comprises a battery or a battery charger or a solar panel system or any combination of at least two of the latter possibilities.

In the apparatus of the invention, the transducer preferably emits waves characterized by a frequency that is lower or equal to 350 KHz, this frequency ranging preferably from 150 to 250 KHz, and being more preferably about 170 or being about 220 KHz.

Advantageously, the transducer emits sinusoidal waves, and more preferably the transducer emits continuous sinusoidal waves.

According to a second broad aspect of the present invention there is provided a method for controlling propagation of cyanobacteria population. Such a cyanobacteria population is for example present in blue-green and/or red tide algae.

The method subjects cyanobacteria to a predetermined frequency at a predetermined acoustical power level to break the chemical bond linking phycocyanin to the photosynthesis system which inhibited chlorophyll a production and private cyanobacteria of one of its vital functions.

There is provided a method for controlling the propagation of cyanobacteria, preferably of the blue-green algae type, population in a body of water by disrupting the photosynthesis process of said cyanobacteria.

According to its broadest meaning, the method of the invention is characterized in that the propagation of cyanobacteria population is controlled by inhibiting the chlorophyll a production.

According to another embodiment, in this method at least one of cyanobacteria vital functions is inhibited.

In this method, the photosynthesis process of the cyanobacteria is modified by breaking the chemical bond between the phycocyanin, (the light-harvesting pigment of the cyanobacteria), and it photosynthesis system.

In this method, the photosynthesis process of said cyanobacteria is modified by breaking the chemical bond between the fucoxanthin, (the light-harvesting pigment of the cyanobacteria), and it photosynthesis system.

Advantageously, the propagation of cyanobacteria population is controlled by exposing the cyanobacteria to ultrasonic waves of a predetermined frequency; this predetermined frequency is preferably lower or equal to 350 KHz. This frequency more preferably ranges from 150 to 250 KHz, or is about 170 or is about 220 KHz.

A high efficiency is reached with the method when the cyanobacteria are exposed to waves with a predetermined power level that ranges from 7 to 20 acoustic Watts, preferably the power level ranges from 10 to 15 acoustic Watts, this power level being preferably about 10 acoustic Watts.

Advantageously, the method of the invention comprises the steps of:
positioning a floatation platform at a predetermined substantially stable position on a body of water, said platform carrying at least one transducer fixed directly under it; and
energizing said ultrasonic transducer to generate a predetermined frequency and power level to create a predetermined ultrasonic field diffused at the top level of said body of water.

The predetermined ultrasonic field is preferably diffused at one to two meters of the top surface.

Advantageously, the ultrasonic generator uses a piezoelectric transducer that is preferably made of piezoelectric ceramic, piezo-composite or even Tonpilz (Langevin transducer) technology.

According to a more preferred embodiment of the invention, the transducer can include an acoustical matching layer to maximize the transmitted energy to the propagation medium.

The ultrasonic generator is advantageously driven by a dedicated electronic system composed of a twin-T bridge RC oscillator, a LC filter, a phase inverter and a power circuit.

A very high efficiency of the method may be reached when the predetermined frequency is about 170 KHz at a predetermined power level from approximately about 10 acoustic Watts.

A very high efficiency of the method may be reached when the predetermined frequency is about 220 KHz at a predetermined power level from approximately about 10 acoustic Watts.

A very high efficiency of the method is reached when applied to blue-green algae and/or to red tide type algae.

A further aspect of the invention is the use of an apparatus as defined in the first aspect of the invention for controlling the cyanobacteria, preferably of the blue-green algae type or preferably of the red tide type.

A further aspect of the invention is the use of an apparatus as defined in the first aspect of the invention for preventing the growth of cyanobacteria, preferably of the blue-green algae type or preferably of the red tide type, in a body of water.

A further aspect of the invention is the use of an apparatus as defined in the first aspect of the invention for inhibiting the growth of cyanobacteria, preferably of the blue-green algae type and/or preferably of the red tide type, in a body of water.

These uses may advantageously be combined with the use of at least one of the following technologies: water agitating, water oxygenation, water filtration, and any appropriate chemical or mechanical treatments.

Cell types (i.e. the cyanobacteria types) and environmental conditions may require specific frequencies or energy power levels. Different species may also require a synergetic combination of ultrasonic frequency, energy levels or therapeutic agents.

### Examples

PROTOCOL—In its work, the applicant sought to determine the number of cells equivalent to a given level of fluorescence. On various known dilutions of cyanobacteria, fluorescence was measured using a fluorometer of mark Turner Designs. They determined the optimal reading of this apparatus by using the data of the straight on a graph of fluorescence according to the dilution ratios. The calculation of the cells in the selected dilution, by means of a hematimeter of Neubauer, made it possible thereafter to produce the number of cellules/mL of cyanobacteria to be used for each measurement of each species tested. The method of the visual calculation comprises a high margin of error. The difference of the number of cells counted between the samples tested and the witnesses must be higher than 33% to be considered significant. Moreover, according to Zhang and Al, one needs a minimum of 5×105 cells/liter (500 000 cells/liter) to obtain an acceptable precision of counting. However, these constraints do not affect the results of the fluorometer witch are of 150 to 150.000 cellules/mL (150 000 to 1.500.000 cells/liter).

The experimental results obtained with the fluorometer confirm the cut of the chemical bond between the phycocyanin and chlorophyll A. When this bond is broken, the transfer of energy collected by the phycocyanin towards chlorophyll is not done any more and the phycocyanin re-emits energy in the form of fluorescence. When that occurs, the fluorescence of the phycocyanin uses to increase. Moreover, when the cells lose the function of photosynthesis, they lose their capacity to survive and to multiply. This was checked by recounting the cells in the suspensions (treated and witness samples) after three days of incubation according to the ultrasonic exposure. An upper deviation than 33% in the account of the cells between the treated sample and the witness indicates that the ultrasounds affect the growth of the cyanobacteria significantly.

In parallel, the fluorescence of chlorophyll remained relatively stable thus illustrating the absence of impact of the ultrasounds on this one.

Each measurement was supplemented starting from conventional instruments of laboratory adapted or modified for an automated management of the tests, namely:
a LABView application for the cyanobacteria treatment with fixed frequency level and the integrated management of each apparatus used, in particular by controlling the stimuli of the ultrasonic waves at fixed frequency, by entering and analyzing the readings of fluorescence;
an ultrasonic amplifier, using a wiring with high voltage of insulation and low capacity to inter-connect the ultrasonic amplifier with the piezoelectric transducer;
a circuit for an automatic capture of the fluorometer data and its interconnection with the LABView acquisition system;
integration of the transducer in the test tube of the fluorometer. Those contain approximately 3.8 ml and measure 12×12×4.3 mm. Piezoelectric films acted like transducers. The frequencies were emitted and controlled by these piezoelectric sources; and
treatments, one 3 minutes duration, in the form of continuous sweeping of frequency from 80 to 250 KHz by increment of 10 KHz, with a power varying from 200 to 360 Vpp. Between each treatment, readings of luminescence and chlorophyll rates were taken using the fluorometer and were entered by the LABView program.

The following examples are given solely as a matter of exemplification and should not be regarded as bringing any limitation to the scope of the present invention.

### Example 1

### First Preferred Embodiment

The applicant developed a fully computerized testing bench in which he integrated a field fluorometer specifically modified for the needs. The bench tests also required specialized equipment such as a power generator capable of achieving a peak of 400 volts (peak to peak) with a maximum bandwidth of 1 MHz±3dB; a low-pass analog 8th order filter driven by a microprocessor; and a conditioner to adapt analog signals for the virtual research instruments. The entire process was directed by an original LABView application which supported each device, coordinated their tasks, and recorded and analyzed the data collected for nearly 3000 tests on as many different frequencies. The main advantage of this procedure was to allow automated tests over a very short period of time and to identify the most promising leads. Significant results were then retested to confirm their consistency. Results were subsequently counter-checked using more traditional methods, including a visual count (Neubauer hematimeter).

Breaking the chemical bond existing between the phycocyanin and the chlorophyll is reflected by an initial increase of fluorescence produced by the phycocyanin, then by a reduction in fluorescence when the crystal structure of the pigment is damaged by the ultrasounds. The applicant surprisingly discovers that this mechanism results in the death of cyanobacteria.

To compare the ultrasound sensitivity of the photosynthetic pigments, four different strains of cyanobacteria were submitted to the frequency of 80 kHz. After this exposure, an increase in phycocyanin fluorescence was surprisingly observed, without observing an increase in the number of counted cells. The applicant therefore established that the ultrasounds had severed the chemical link between the phycocyanin and the photosynthesis system of the cyanobacteria. The bench test solution thus allowed for quick access to tests results aimed at measuring the impact of a frequency on phycocyanin and photosynthesis by increasing fluorescence.

However, it was the additional cyanobacteria count test that enabled to observe a lethal effect after ultrasonic treatment. An increase in the phycocyanin profile was reflected by a decrease in living cyanobacteria after a few hours. The same results were surprisingly obtained with various strains in new tests. It was therefore deducted that phycocyanin is sensitive to certain low ultrasonic frequencies and that severing the chemical link with the photosynthesis system inevitably leads to the death of the cyanobacteria.

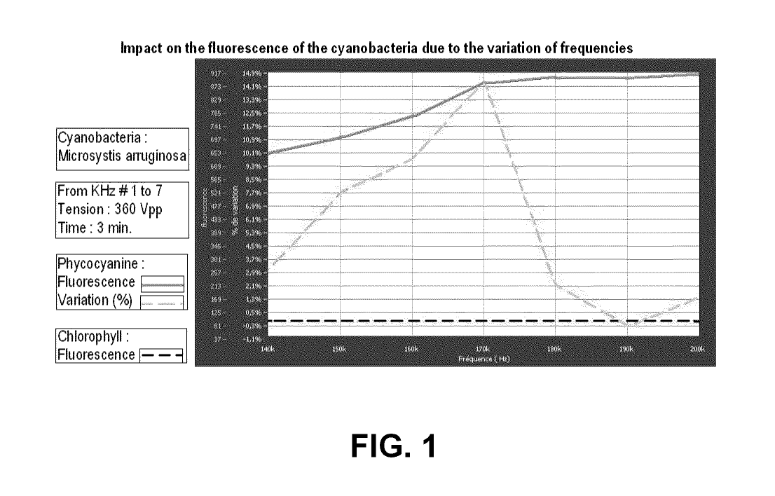

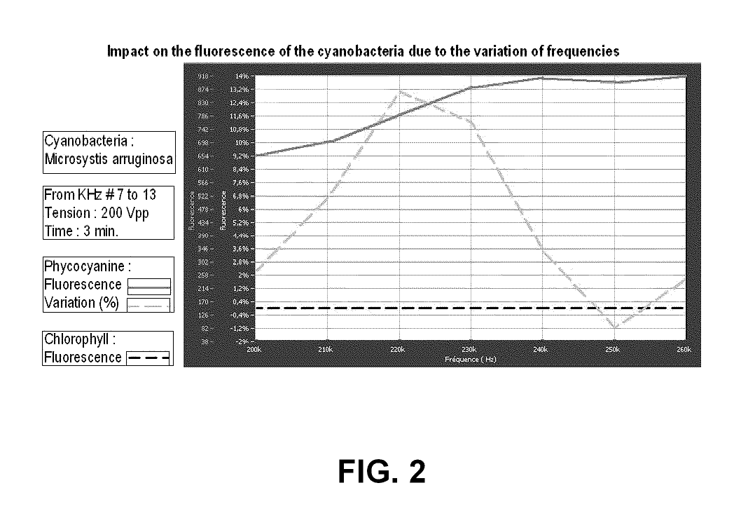

The applicant surprisingly detected two promising frequencies for the treatment of cyanobacteria. In order to ensure that there was no impact on aquatic flora; levels of chlorophyll a were also measured. In every case, no significant variation in the level of chlorophyll a was observed. The following tables, in FIG. 1 and in FIG. 2, illustrate the test results with the carrier frequencies. Frequencies of 170 KHz (FIGS. 1) and 220 KHz (FIG. 2) had significant impacts. Frequency 170 KHz—3 minutes with an excitation voltage of 360 Vpp led to an increase in fluorescence of 14.45%. A 27.1% decrease in cyanobacteria was observed during a visual count. Frequency 220 KHz was terminated after 3 minutes with an excitation voltage of 200 Vpp. The excitation amplitude was decreased in order to avoid cavitation and saturation of the measurement system. An increase in fluorescence of 13.08% was nonetheless noted. Also observed, a 20.8% decrease in cyanobacteria has been noted during the visual count. It appears that better results will be obtained with 220 KHz frequency given the excitation magnitude decrease of 44.4% compared to 170 KHz.

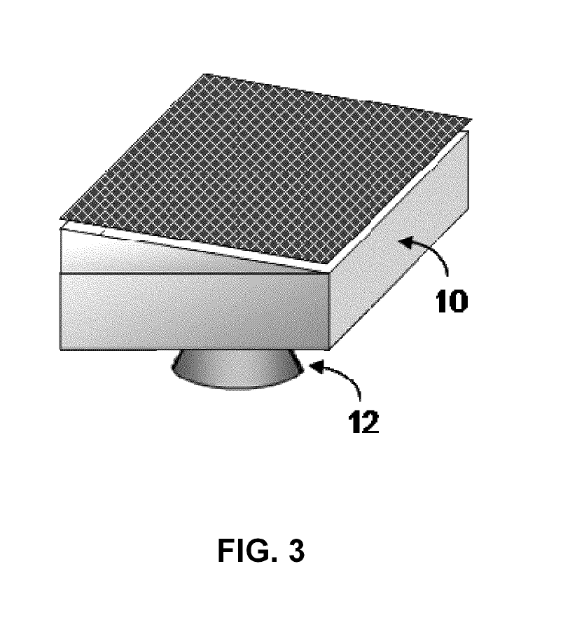

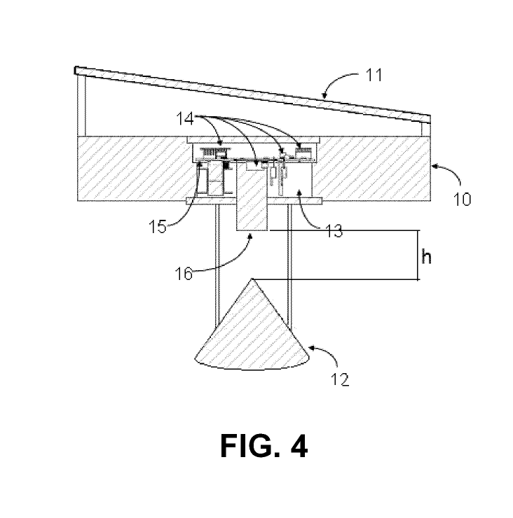

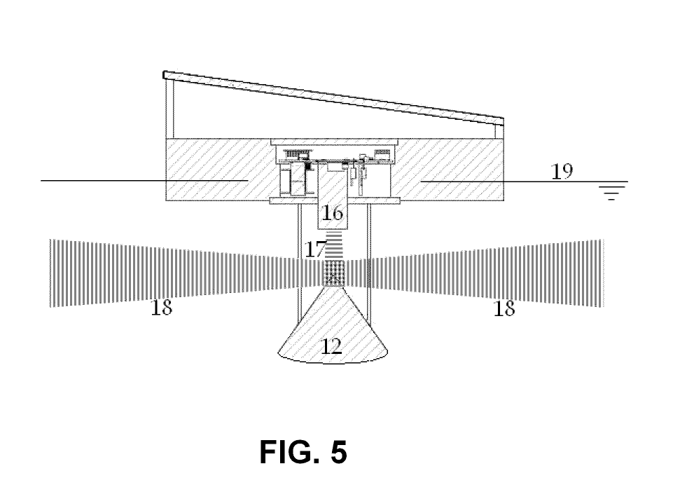

The main goal was to design an autonomous device (renewable energy), as shown in FIGS. 3 to 6. This choice was imposed by the environment and conditions in which the transducer would have to perform (aquatic environment generally without access to electrical supply). Thus, solar power integrated on a floating platform 10 by the mean of a solar panel 11 was chosen. This infrastructure enables the transducer 16 to float and operate autonomously. This also allows the transducer 16 to manage its own operation and calibration when it is activated by the mean of the dedicated driving circuit located in a housing 13, and made of electronic components 14 mounted on a printed circuit board 15. The transducer 16 generates an ultrasonic beam 17 that is spread by the diffuser 12 into a narrow ultrasonic field 18 that propagates just below the water surface 19.

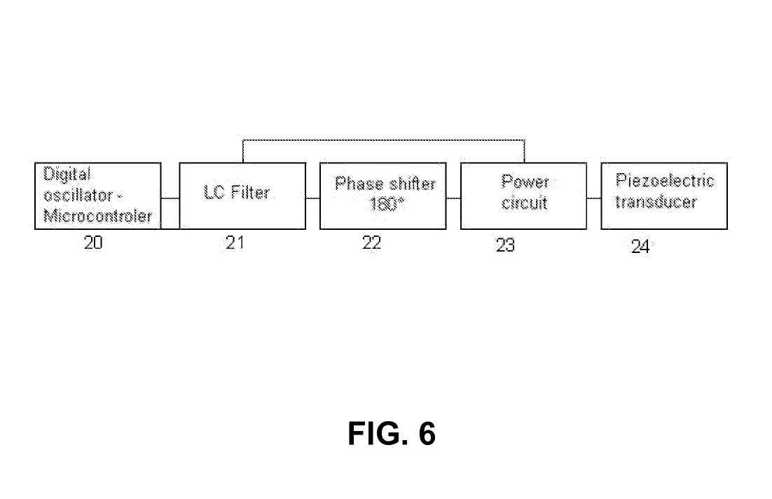

The dedicated electronic circuit is illustrated on the block diagram on FIG. 6. It is made of a twin-T bridge RC oscillator 20, a LC filter 21, and a 180° phase inverter 22 and a power circuit 23. The oscillator 20 is characterized by its high-pass and low-pass filters that allow selecting the operating frequency. It can be easily adjustable by the mean of a potentiometer. It is made of operational amplifiers and some passive components. The LC filter 21 performs the noise filtration and deletes unwanted harmonics. It is made of passive components. The phase inverter 22 creates a second sinus wave, which is 180 phase shifted. It is made of operational amplifiers. The power circuit 23 is dedicated to the transformation of a low amplitude sinus wave to a high amplitude sinus wave able to withstand a power load. The piezoelectric power ultrasonic transducer 24 is the last element connected to this circuit. It can use a Tonpilz, ceramic or piezo-composite technology. A 12-volt version of the apparatus has also been designed.

### Example 2

The Applicant developed a fully computerized testing bench in which he integrated a field fluorometer specifically modified for experimental needs. The bench tests also required specialized equipment such as a power generator capable of achieving a peak of 400 volts (peak to peak) with a maximum bandwidth of 1 MHz±3dB; a low-pass analog 8th order filter driven by a microprocessor; and a conditioner to adapt analog signals for the virtual research instruments. The entire process was directed by an original LABView application which supported each device, coordinated their tasks, recorded and analyzed the data collected for nearly 3000 tests on as many different frequencies. The main advantage of this procedure was to allow automated tests over a very short period of time and to identify the most promising leads. Significant results were then retested to confirm their consistency. Results were subsequently counter-checked using more traditional methods, including a visual count (Neubauer hematimeter).

Breaking the chemical bond existing between the phycocyanin and the chlorophyll a is reflected by an initial increase of fluorescence produced by the phycocyanin, then by a reduction in fluorescence when the crystal structure of the pigment is damaged by the ultrasounds. The applicant surprisingly discovers that this mechanism results in the death of cyanobacteria.

To compare the ultrasound sensitivity of the photosynthetic pigments, four different strains of cyanobacteria were submitted to the frequency of 80 kHz. An increase in phycocyanin fluorescence, without increasing the number of counted cells, was observed. Thus the applicant established that the ultrasounds had severed the chemical link between the phycocyanin and the photosynthesis System of the cyanobacteria. The bench test solution thus allowed for quick access to tests results aimed at measuring the impact of a frequency on phycocyanin and photosynthesis by increasing fluorescence.

However, it was the additional cyanobacteria count test that enabled to observe a lethal effect after ultrasonic treatment. An increase in the phycocyanin profile was reflected by a decrease in living cyanobacteria after a few hours. The same results were obtained with various strains in new tests. Thus the applicant established that phycocyanin is sensitive to certain low ultrasonic frequencies and that severing the chemical link with the photosynthesis system inevitably leads to the death of the cyanobacteria.

Two promising frequencies for the treatment of cyanobacteria were detected. In order to ensure that there was no impact on aquatic flora; levels of chlorophyll a were also measured. In every case, no significant variations in the level of chlorophyll a were observed. The following tables illustrate the test results with the carrier frequencies. Frequencies Hz 4 (first table) and Hz 9 (second table) had significant impacts. Frequency Hz 4—3 minutes at 360 Vpp led to an increase in fluorescence of 14.45%. A 27.1% decrease in cyanobacteria was observed during a visual count. Frequency Hz 9 was terminated after 3 minutes at 200 Vpp. The amplitude was decreased in order to avoid cavitation and saturation of the measurement System. The applicant nonetheless noted an increase in fluorescence of 13.08%. The applicant also observed a 20.8% decrease in cyanobacteria during the visual count. It appears that better results would be obtained with Hz 9 frequency given the stimulus magnitude decrease of 44.4%.

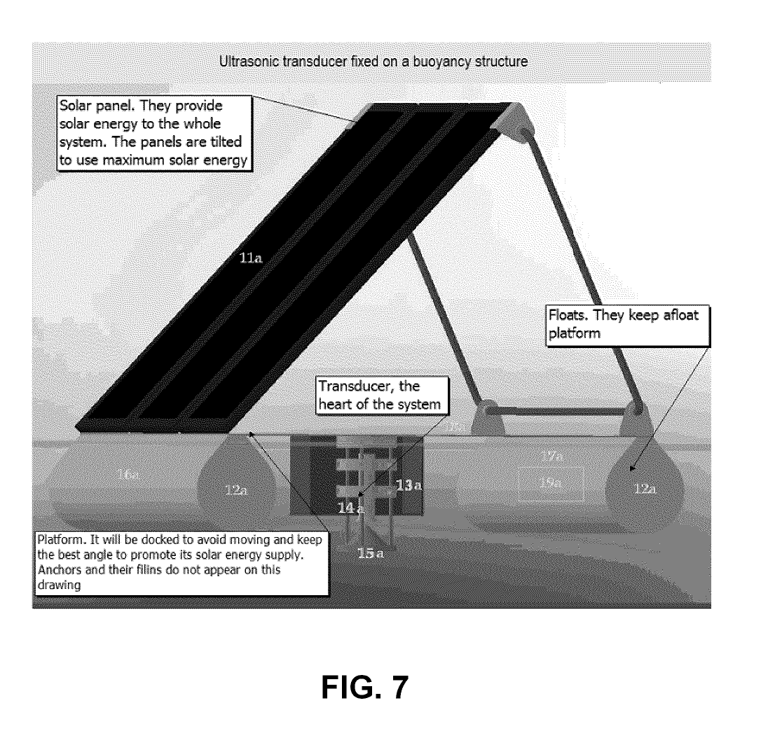

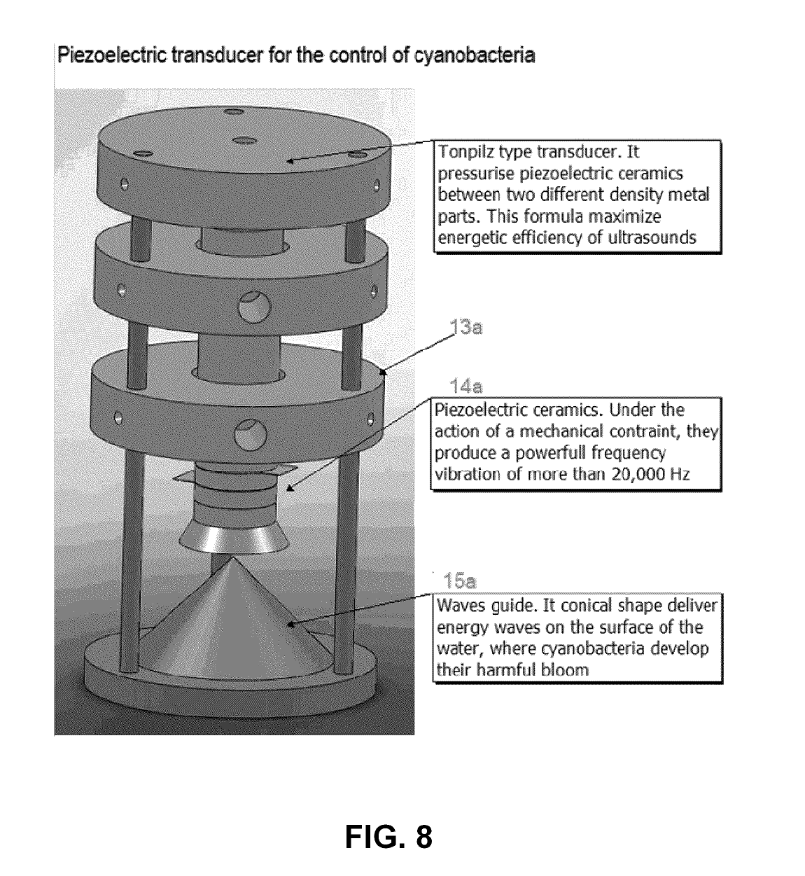

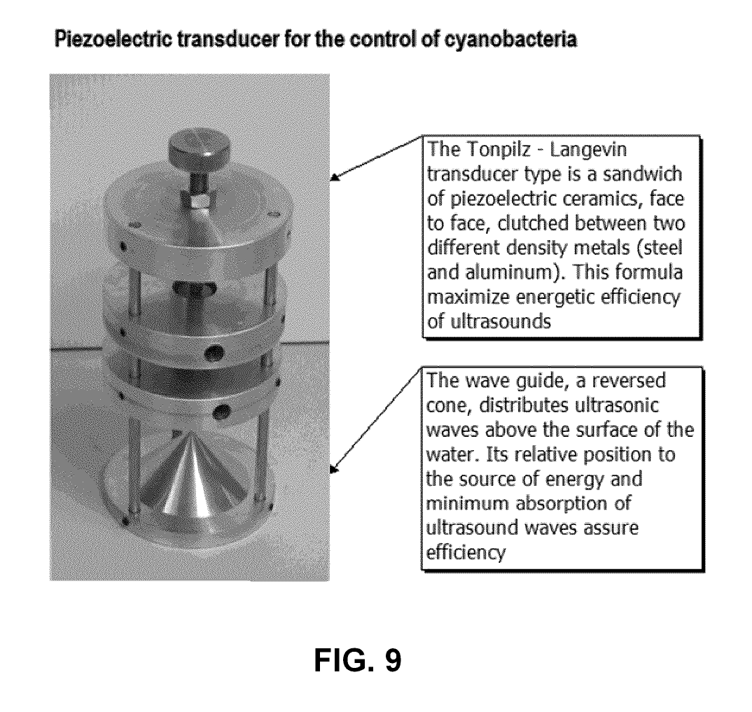

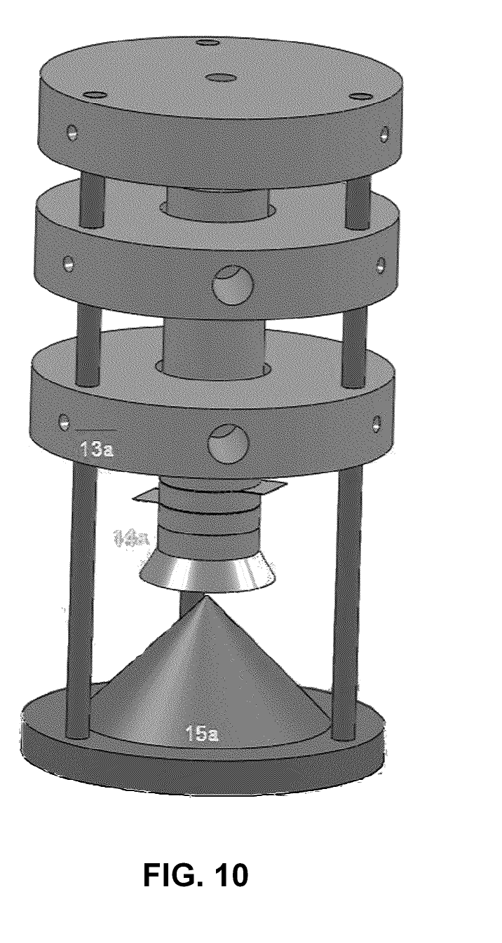

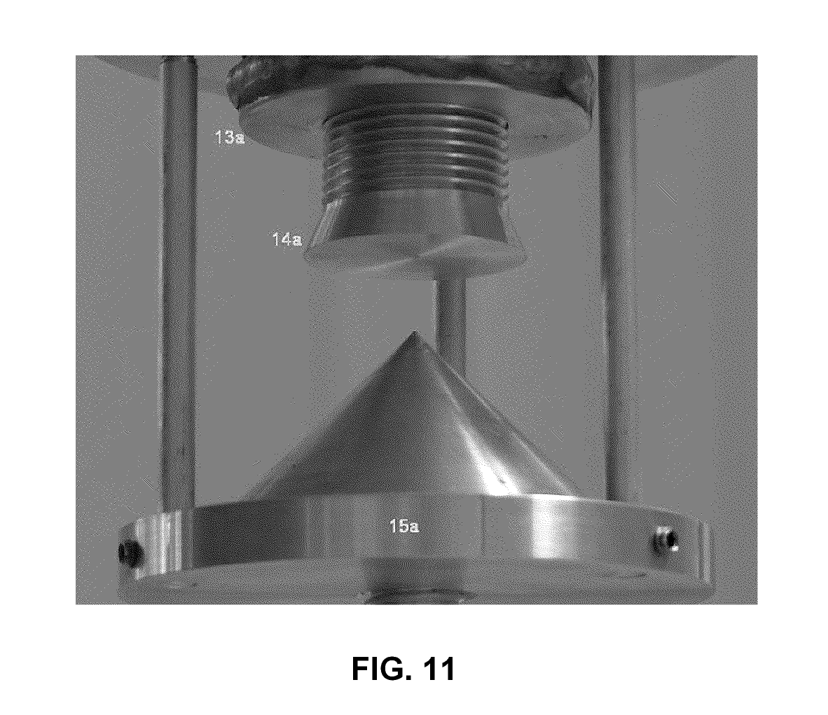

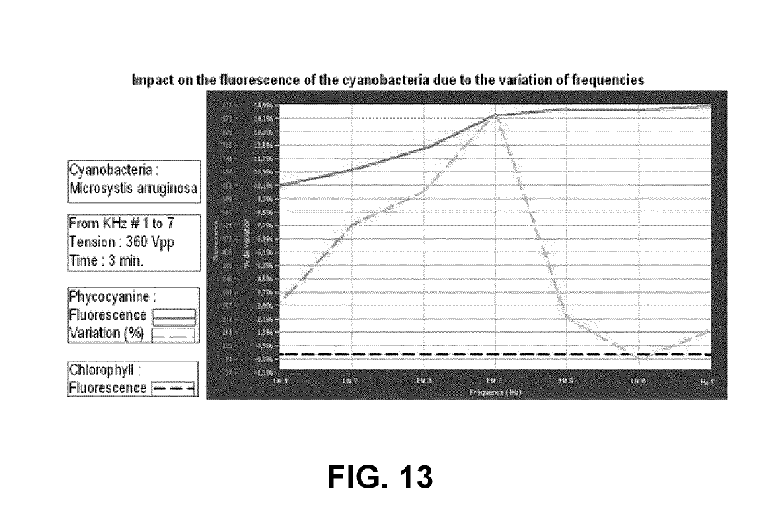

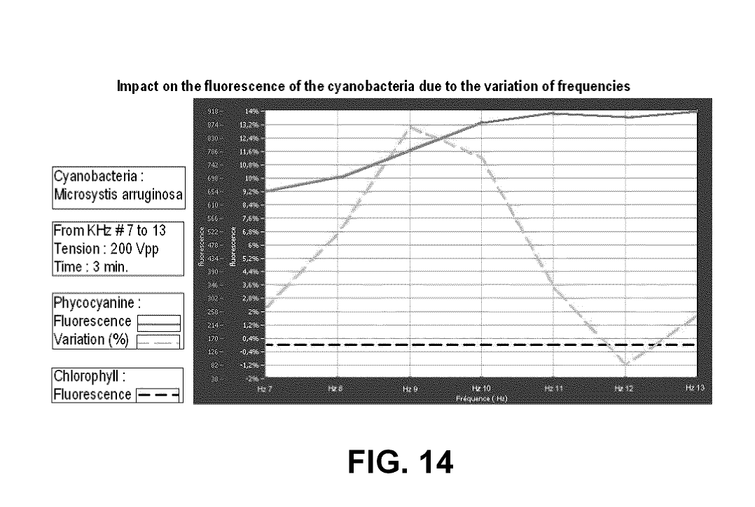

The main goal was to design an autonomous transducer (renewable energy), as shown in FIGS. 7 to 15. This choice was imposed by the environment and conditions in which the transducer would have to perform (aquatic environment without access to electrical supply). Solar powered super capacitors were selected. A floating platform 10a (see FIG. 7) was also designed and equipped with variable angle solar panels 11a allowing for proper sun exposure in every region of the world. An anchoring system 12a which points the system to the south was also designed. This infrastructure enables the transducer 13a to float and operate autonomously. This also allows the transducer to manage its own operation and calibration when it is activated. A 12-volt version has also been designed.

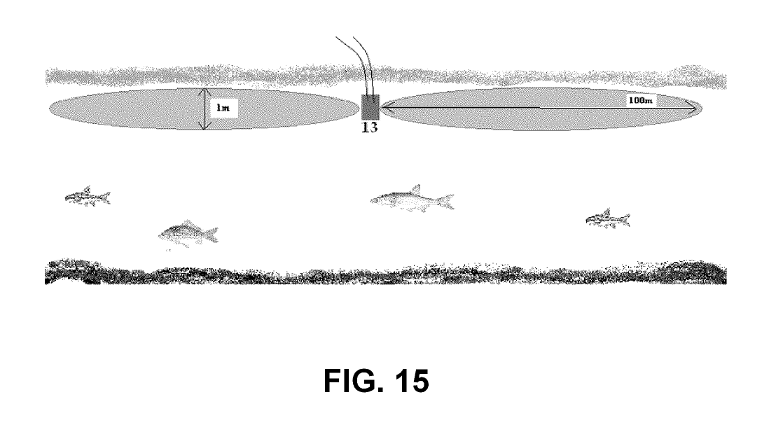

Despite the low energy need for this type of ultrasonic device, the Applicant wanted to ensure high yield output. While the transducers project like a canon at a relatively narrow elliptical angle (approximately 30° over 50 meters), see FIG. 15, the applicant chose to project a controlled pattern all around the transducer, i.e. a 1- to 2-meter deep circle with an expected radius of approximately 100 meters.

In this context, the Applicant uses a frequency below 250 kHz to maximize its underwater broadcasting potential since higher frequencies don't travel as far.

The transducer 13a is a Tonpilz-Langevin transducer type (a sandwich 14a of face-to-face piezoelectric ceramics placed between two different density metals (steel and aluminum). The power emission is thus increased and it is directed entirely towards the impedance adapter (less dense metal), allowing increased coupling in water. Modeling from density, shape, absorption, and scope calculations has allowed us to optimize the power.

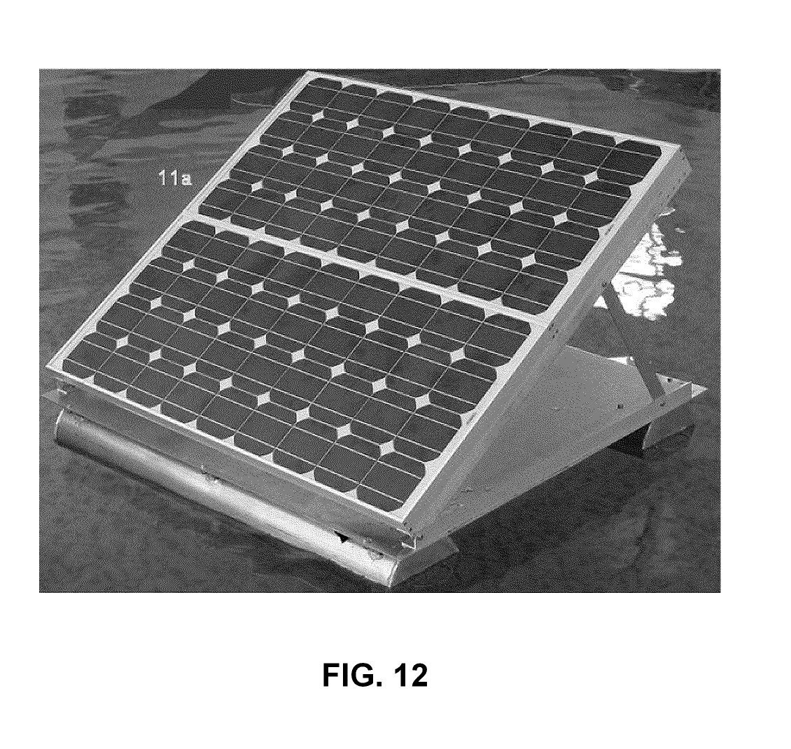

The wave guide is a reversed cone 15a to distribute ultrasonic waves at the water surface 16a. Particular attention was paid to its position relative to the energy source. The metal was chosen for maximum reduction of ultrasound wave absorption. The floats 17a keep the platform 18a afloat. Batteries 19a are stored in compartments inside the floats and provide the electric energy required. The solar panel 11a (see FIGS. 7 and 12) recharges the batteries and point in the direction of the sun.

The apparatus of the invention surprisingly show relative lightness, efficiency, reliability, autonomy and a bright diffusion area. Moreover, the corresponding method revealed to be particularly efficient without generating damageable effects on the environment. This was confirmed by the numerous repetitive successful tests performed in the framework of example 1 and of example 2.

Although the present invention has been described with the aid of specific embodiments, it should be understood that several variations and modifications may be grafted onto said embodiments and that the present invention encompasses such modifications, usages or adaptations of the present invention that will become known or conventional within the field of activity to which the present invention pertains, and which may be applied to the essential elements mentioned above.

1. An apparatus for controlling the cyanobacteria, said apparatus comprising:
a floatation platform having anchor means to position said platform on a body of water;
an ultrasonic generator secured to said platform and adapted to generate ultrasonic waves at below and top of said body of water; and
supply means to cause said ultrasonic generator suspended at a predetermined depth to emit said ultrasonic waves, of a predetermined frequency, at a predetermined power level, to sever the chemical link existing between an accessory pigment and the chlorophyll a, both present in the photosynthesis system of the cyanobacteria.

2. The apparatus according to claim 1, characterized in that the cyanobacteria are those present in blue-green algae and the chemical link is between phycocyanin and chlorophyll a.

3. The apparatus according to claim 1, characterized in that the cyanobacteria are those present in red tide and the chemical link is between fucoxanthin and chlorophyll a.

4. The apparatus according to any one of claims 1 to 3, characterized in that said ultrasonic frequency generator is a piezoelectric transducer having a diffuser (wave guide component) configured to produce an oriented narrow ultrasonic beam.

5. The apparatus according to claim 4, characterized in that said narrow ultrasonic beam has a circular diffusion area.

6. The apparatus according to claim 5, characterized in that the narrow ultrasonic beam has a diffusion area extending over a radius of 100 meters.

7. The apparatus according to claim 6, characterized in that said circular diffusion area has an average depth, measured from the surface of said body of water and in direction of the bottom, ranges from 0 to 3 meters and preferably ranges from 0 to about 2 meters.

8. The apparatus according to claim 6 or 7, characterized in that said circular diffusion area has an ultrasonic operative radius ranging from 75 to 100 meters, and this radius is preferably of about 100 meters.

9. The apparatus according to any one of claims 1 to 8, characterized in that said diffuser component is an inverted cone positioned on a support base secured at a predetermined distance below said transducer.

10. The apparatus according to claim 9, characterized in that the predetermined distance (h) below said transducer ranges from 10 to 20 cm, and preferably ranges from 10 to 15 cm, and more preferably is about 13 cm.

11. The apparatus according to claim 9 or 10, characterized in that the diameter of the cone basis is greater or equal to the diameter of the transducer.

12. The apparatus according to any one of claims 9 to 11, characterized in that the angle at the basis of the cone ranges from 30 to 80 degrees, and preferably from 40 to 50 degrees, and more preferably is about 45 degrees.

13. The apparatus according to any one of claims 1 to 12, characterized in that said supply means is a energy supply, preferably with a voltage ranging from 11.5 to 18 Volts, more preferably the energy supply has a voltage of about 12 Volt.

14. The apparatus according to any one of claims 1 to 13, characterized in that the supply means comprises a battery or a battery charger or a solar panel system or any combination of those possibilities.

15. The apparatus according to any one of claims 1 to 14, characterized in that the transducer emits waves characterized by a frequency that is lower or equal to 350 KHz, this frequency ranging preferably from 150 to 250 KHz, and being more preferably about 170 or being about 220 KHz.

16. The apparatus according to claim 15, characterized in that the transducer emits sinusoidal waves.

17. The apparatus according to claim 16, characterized in that the transducer emits continuous sinusoidal waves.

18. A method for controlling the propagation of cyanobacteria, preferably of the blue-green algae type or of the red tide type, population in a body of water by disrupting the photosynthesis process of said cyanobacteria.

19. The method according to claim 18, characterized in that the propagation of cyanobacteria population is controlled by inhibiting the chlorophyll a production.

20. The method according to claim 18 or 19, characterized in that at least one of cyanobacteria vital functions is inhibited.

21. The method according to any one of claims 18 to 20, characterized in that the photosynthesis process of said cyanobacteria is modified by breaking the chemical bond between the phycocyanin, (the light-harvesting pigment of the cyanobacteria in the blue-green algae type), and it photosynthesis system.

22. The method according to claim 21, characterized in that the photosynthesis process of said cyanobacteria is modified by breaking the chemical bond between the fucoxanthin, (the light-harvesting pigment of the cyanobacteria of the red tide type), and it photosynthesis system.

23. The method according to any one of claims 18 to 22, characterized in that the propagation of cyanobacteria population is controlled by exposing the cyanobacteria to ultrasonic waves of a predetermined frequency.

24. The method according to claim 23, characterized in that the cyanobacteria are exposed to waves with a frequency lower or equal to 350 KHz, this frequency ranging preferably from 150 to 250 KHz, and being more preferably about 170 or being about 220 KHz.

25. The method according to claim 23 or 24, characterized in that the cyanobacteria are exposed to waves with a predetermined power level ranging from 7 to 20 acoustic Watts, preferably ranging from 10 to 15 acoustic Watts this power level being preferably about 10 acoustic Watts.

26. The method according to any one of claims 18 to 25, characterized in that it comprises the steps of:
positioning a floatation platform at a predetermined substantially stable position on a body of water, said platform carrying at least one transducer fixed directly under it; and
energizing said ultrasonic transducer to generate a predetermined frequency and power level to create a predetermined ultrasonic field diffused at the top level of said body of water.

27. The method according to claim 26, characterized in that the predetermined ultrasonic field is diffused at one to two meters of the top surface.

28. The method according to according to any one of claims 18 to 27 characterized in that said ultrasonic generator uses a piezoelectric transducer that is preferably made of piezoelectric ceramic, piezo-composite or even Tonpilz (Langevin transducer) technology.

29. A method according to claim 28, characterized in that said transducer can include an acoustical matching layer to maximize the transmitted energy to the propagation medium.

30. The method according to any one of claims 18 to 29, characterized in that said ultrasonic generator is driven by a dedicated electronic system composed of a twin-T bridge RC oscillator, a LC filter, a phase inverter and a power circuit.

31. The method according to any one of claims 18 to 30, characterized in that said predetermined frequency is about 170 KHz at a predetermined power level from approximately about 10 acoustic Watts.

32. The method according to any one of claims 18 to 31, characterized in that said predetermined frequency is about 220 KHz at a predetermined power level from approximately about 10 acoustic Watts.

33. Use of a apparatus as defined in any one of claims 1 to 17 for controlling the cyanobacteria, preferably of the blue-green algae type or preferably of the red tide type.

34. Use according to claim 33 for preventing the growth of cyanobacteria, preferably of the blue-green algae type or preferably of the red tide type, in a body of water.

35. Use according to claim 33 for inhibiting the growth of cyanobacteria, preferably of the blue-green algae type or preferably of the red tide type, in a body of water.

36. Use according to any one of claims 33 to 35, in combination with the use of at least one of the following technologies:
water agitating;
water oxygenation;
water filtration; and
any appropriate chemical and/or mechanical treatments.
